(19) United States
(12) Patent Application Publication
(10) Pub. No.: US 2004/0100182 A1
(43) Pub. Date: May 27, 2004

(54) Dielectric barrier discharge lamp and use of this lamp for viewing x-rays

(75) Inventors: Udo Custodis, Munchen (DE); Renate Hirrle, Augsburg (DE); Kunz von Kriegelstein, Ottobrunn (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 10/706,076

(22) Filed: Nov. 13, 2003

(30) Foreign Application Priority Data
Nov. 20, 2002 (DE) 102 54 208.2

(51) Int. Cl. H01J 1/62; H01J 63/04

(52) U.S. Cl. 313/486

(57) ABSTRACT

The invention proposes a dielectric barrier discharge lamp having a phosphor mixture and the use of a dielectric barrier discharge lamp with a color temperature of at least 10,000 K for viewing X-rays. The phosphor mixture consists of the phosphor components R: europium-activated yttrium gadolinium borate ([Y, Gd]BO₃:Eu),G: terbium-activated lanthanum phosphate (LaPO₄: [Tb]) or cerium- and terbium-activated lanthanum phosphate (LaPO₄:[Ce,Tb]) and B: europium-activated barium magnesium aluminate (BaMgAl₁₀O₁₇:Eu). The following applies to the proportions by weight in the mixture: 0.05≦R≦0.15, 0.50≦G≦0.70, 0.20≦B≦0.40 and R+G+B=1.

### TECHNICAL FIELD

The invention is based on a dielectric barrier discharge lamp having a phosphor layer.

In this context, the term “dielectric barrier discharge lamp” encompasses sources of electromagnetic radiation based on dielectric barrier gas discharges.

By definition, a dielectric barrier discharge lamp requires at least one so-called dielectric barrier electrode. A dielectric barrier electrode is separated from the interior of the discharge vessel or from the discharge medium by means of a dielectric. This dielectric—which constitutes the actual dielectric barrier—may, for example, be designed as a dielectric layer which covers the electrode, or alternatively it may be formed by the discharge vessel of the lamp itself, specifically if the electrode is arranged on the outer side of the wall of the discharge vessel. In the case of lamps in which it is defined whether the electrodes operate as cathodes or anodes, i.e. for operation with unipolar voltage pulses, at least the anodes are dielectrically separated from the discharge medium (cf. U.S. Pat. No. 5,604,410).

The ionizable discharge medium usually consists of a noble gas, for example xenon, or a gas mixture. During the gas discharge, which is preferably operated by means of a pulsed operating method described in U.S. Pat. No. 5,604,410, what are known as excimers are formed. Excimers are excited molecules, e.g. Xe₂*, which emit electromagnetic radiation when they return to the generally unbonded ground state. In the case of Xe₂*, the maximum of the molecular band radiation lies at approx. 172 nm, in the region of the VUV radiation.

The present invention, however, relates to a variant in which a phosphor layer for converting the VUV radiation into radiation with longer wavelengths, in particular visible radiation (light), is additionally provided.

### BACKGROUND ART

A dielectric barrier discharge lamp having a phosphor layer for general-purpose illumination is known from U.S. Pat. No. 5,604,410, which has already been cited above. The phosphor layer consists of a three-band phosphor with the red phosphor component (R) gadolinium yttrium borate ((Gd, Y)BO₃:Eu), the green phosphor component (G) lanthanum phosphate (LaPO₄:(Ce, Tb)) and the blue phosphor component (B) barium magnesium aluminate (BaMgAl₁₀O₁₇:Eu). A color temperature of 4000 K and a color locus having coordinates x=0.38 and y=0.377 in accordance with the table of color standards in accordance with CIE are given for this lamp.

U.S. Pat. No. 6,034,470 shows a flat dielectric barrier discharge lamp which is likewise provided with the above-mentioned three-band phosphor. This flat lamp is intended in particular for the backlighting of liquid crystal display screens.

U.S. Pat. No. 5,714,835 has disclosed a dielectric barrier discharge lamp for general-purpose illumination having a phosphor coating which also comprises the abovementioned RGB components. The claimed ranges for the proportions by weight in the mixture are 0.2<R<0.5, 0.4<G<0.7 and 0.05<B<0.15, with R+G+B=1.

### DISCLOSURE OF THE INVENTION

The object of the present invention is to widen the range of possible applications for dielectric barrier discharge lamps.

This object is achieved by a dielectric barrier discharge lamp having

a discharge vessel, the wall of which encloses a discharge medium,

a set of electrodes for generating dielectric barrier discharges in the discharge medium, with a dielectric barrier action in respect of at least some of the set of electrodes,

a phosphor mixture, which is applied to part of the wall of the discharge vessel,

a phosphor mixture comprising the following phosphor components:

R: (Y,Gd)BO₃: Eu,

LaPO₄: (Tb) or LaPO₄: (Ce,Tb),

B: BaMgAl₁₀O₁₇:Eu

whereby the following applies to the proportions by weight formed by the phosphor components R, G, B in the mixture:

0.05≦R≦0.15, 0.50≦G≦0.70, 0.20≦B≦0.40 and R+G+B=1.

The invention also claims protection for the use of the dielectric barrier discharge lamp according to the invention for the viewing of X-rays, in particular also in conjunction with a dielectric barrier discharge lamp according to the invention of flat design for diffuse backlighting.

The invention proposes a dielectric barrier discharge lamp having a phosphor mixture, the phosphor mixture consisting of the following phosphor components:

R: europium-activated yttrium gadolinium borate ([Y,Gd]BO₃:Eu),

G: terbium-activated lanthanum phosphate (LaPO₄:[Tb]) or cerium- and terbium-activated lanthanum phosphate (LaPO₄: [Ce,Tb]), and

B: europium-activated barium magnesium aluminate (BaMgAl₁₀O₁₇: Eu).

The following applies to the proportions by weight in the mixture:

0.05≦R≦0.15, 0.50≦G≦0.70, 0.20≦B≦0.40 and R+G+B=1,

preferably

0.06≦R≦0.12, 0.58≦G≦0.66, 0.25≦B≦0.35 and R+G+B=1.

The ranges given above for the proportions by weight of the respective components in the phosphor mixture take account, inter alia, of the inaccuracies and tolerances which always occur in practice, for example the fact that the quantum efficiencies of different phosphor batches typically differ slightly on account of slight manufacturing fluctuations, etc.

Moreover, the focal point of fine-tuning of the phosphor mixture, in particular the color temperature, may differ slightly according to the specific use. All this can be successfully controlled using suitable tests carried out on a small number of finely graded mixture variations within these ranges.

For specific details on the weight ratios of the individual phosphor components R, G, B of a dielectric barrier discharge lamp which is particularly suitable especially for the viewing of X-rays, reference is made to the description of the exemplary embodiment.

In one preferred embodiment, the dielectric barrier discharge lamp according to the invention is filled with Xenon, typically with a filling pressure in the range from 50 to 200 mbar, preferably between 100 and 150 mbar. As a result, the dielectric barrier discharge generates xenon excimer band radiation with a maximum at approx. 172 nm, which excites the phosphors. The quantum efficiency of the phosphors for this exciting radiation should be taken into account both when selecting the phosphor components and when selecting their ratios in the mixture, in order to ensure the highest possible light yield. A further aspect is the maintenance of the phosphor components during long-term excitation with this radiation. In this case, for each phosphor component, the minimum possible decrease in the intensity of the converted radiation during the service life of dielectric barrier discharge lamps of typically at least 20,000 hours is desired in order to ensure a constant color locus during the service life. This is especially important when viewing X-rays, in order to ensure good reproducibility of the visual impression when viewing X-rays, the X-rays being backlit using the dielectric barrier discharge lamp according to the invention

It has been found that it is expedient if the dielectric barrier discharge lamp used to view X-rays, in particular in mammography, has a color temperature of 10,000 K or above. The color temperature is preferably more than 20,000 K, particularly preferably more than 30,000 K, very particularly preferably more than 40,000 K. Without seeking to intimate any restriction on the basis of the following explanation, these experimental observations are currently thought to be associated with the following fact. Currently, X-ray films with a transmission maximum in the blue spectral region of light are generally used. If a light source which contains primarily blue spectral fractions (high color temperature) is used for the backlighting of the developed X-ray films, a correspondingly higher proportion of the lamp light flux is available for viewing through the film. Furthermore, “blue light” is subjectively considered much brighter than “reddish light” (lower color temperature). As a result, when X-rays are backlit using the abovementioned dielectric barrier discharge lamp, the contrast and therefore also the differentiation capacity when viewing the X-ray are improved. In this context, it has been found that even from a color temperature of approx. 10,000 K, the contrast is considerably improved compared to warmer light colors (“reddish light”), for example with a color temperature of 4000 K as is customary for general-purpose illumination. By further increasing the color temperature, for example to over 20,000 K, 30,000 K or even 40,000 K, it is even possible to still further improve the suitability for viewing X-rays.

In a particularly advantageous embodiment, the dielectric barrier discharge lamp according to the invention is designed as what is known as a flat lamp. Contrary to the light sources which are currently customary for viewing X-ray film, with their extreme luminances, which cause considerable dazzling of the person viewing the X-rays, the flat lamp according to the invention is distinguished by a luminance which is high and in particular extremely homogeneous over the substantially planar discharge surface, allowing backlighting virtually without dazzling. This considerably facilitiates reliable diagnosis for the physician, improving it in critical situations, in particular in mammography. Details of the flat lamp according to the invention are to be found in the exemplary embodiment.

In principle, the dielectric barrier discharge lamp according to the invention can also be of tubular design. For the purposes of backlighting, the light from this lamp is usually introduced into the narrow side of an optical conductor plate, e.g. a plexiglass plate (known as the edgelight technique). The light from the lamp is then discharged in substantially diffuse form via a wide side of the optical conductor plate and therefore likewise serves as a large-area light source for backlighting. This technique is fundamentally known and of only marginal interest in the present context, and will therefore not be described in more detail at this point.

In addition to its use for the backlighting of X-rays, the dielectric barrier discharge lamp according to the invention is also suitable for other application areas for which a high color temperature is required or at least desirable, e.g. for the backlighting of liquid crystal display screens (LCDs) for special applications, in particular for monochrome LCDs.

### BRIEF DESCRIPTION OF THE DRAWINGS

The invention is to be explained in more detail below on the basis of an exemplary embodiment. In the drawing:

FIG. 1a shows a diagrammatic plan view of a dielectric barrier discharge lamp according to the invention,

FIG. 1b shows a diagrammatic side view of the lamp shown in FIG. 1a,

FIG. 2 shows the basic conditions of the electrode structure for a flat lamp according to the invention with a diagonal of 6.8″ which is preferably to be operated with unipolar voltage pulses.

### BEST MODE FOR CARRYING OUT THE INVENTION

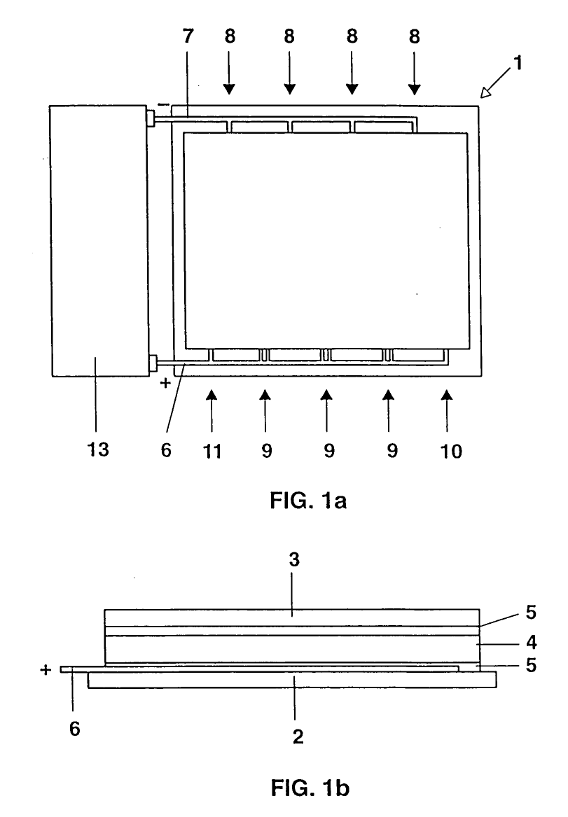

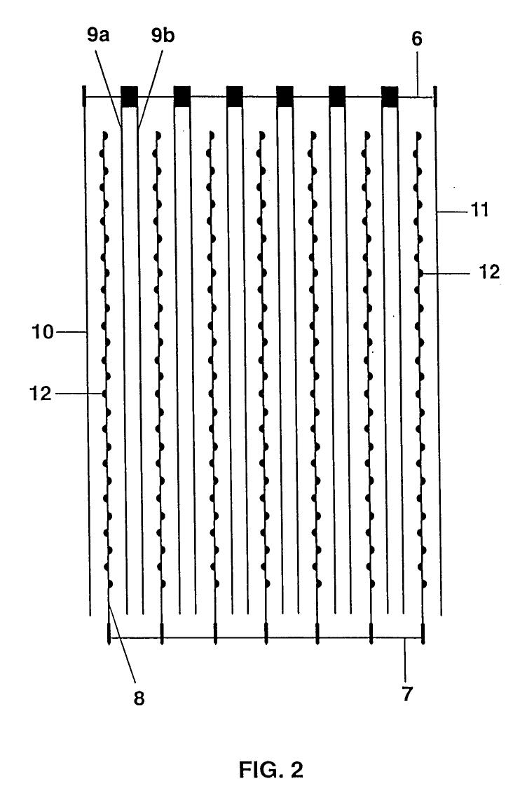

FIGS. 1a, 1b respectively show a diagrammatic plan view and side view of a dielectric barrier discharge lamp 1 according to the invention. This is a flat dielectric barrier discharge lamp for the backlighting of X-rays, in particular for mammography. Purely to simplify the illustration, a lamp with a relatively small number of electrode strips and consequently a relatively short lamp diagonal is shown. This aspect will be explained in more detail below in connection with FIG. 2. The basic mechanical and electrical structure of this flat lamp in any case substantially corresponds to that of the lamp disclosed in U.S. Pat. No. 6,034,470, which was cited above. The main difference is in the phosphor layer. Before this is dealt with in detail, the basic structure of the lamp 1 according to the invention will be outlined with reference to FIGS. 1a, 1b.

The flat lamp 1 comprises a flat discharge vessel with a rectangular basic area and a set of electrodes arranged inside the discharge vessel. The discharge vessel for its part comprises a back plate 2, a front plate 3 and a frame 4, in each case made from glass. Back plate 2 and front plate 3 are in each case joined to the frame 4 in a gastight manner by means of soldering glass 5, in such a manner that the interior of the discharge vessel is of cuboidal form. The interior of the discharge vessel is filled with xenon with a pressure of approx. 130 mbar. The back plate 2 is larger than the front plate 3, such that the discharge vessel has a projecting edge all the way around. Two supply conductors 6, 7, which resemble conductor tracks, for the set of electrodes are applied to this edge.

The inner surface of the front plate 3 is coated with a three-band phosphor mixture (not visible in the drawing), which converts the UV/VUV radiation generated by the discharge into visible light. This phosphor comprises the red phosphor component (Y, Gd,)BO₃:Eu (NP 360-03 produced by Nichia), the green phosphor component La-PO₄: (Ce, Tb) (2213 CCSX produced by OSRAM Sylvania Inc.) and the blue phosphor component BaMgAl₁₀O₁₇:Eu (NP 107-44 produced by Nichia) in the associated proportions by weight of 8%, 62% and 30%. Consequently, the lamp has a color temperature of approx. 50,000 K and a color locus having the coordinates x=0.236 and y=0.240 in accordance with the CIE color standards table.

To improve the clarity of the drawing, a representative layout of a set of electrodes for a lamp diagonal of 6.8″ for the lamp illustrated in FIGS. 1a, 1b is diagrammatically depicted in FIG. 2. In the case of a lamp with a larger diagonal, there are no changes to the basic layout of the set of electrodes, but rather it is simply the case that a correspondingly greater number of and longer electrode strips are required. The set of electrodes comprises a conductor track-like structure having strip-like metallic cathodes 8 and anodes 9, 10, 11 which are arranged alternately and parallel to one another on the inner surface of the back plate 2. The cathode strips 8 deliberately have spatially preferred starting points for the individual discharges formed in pulsed operation (cf. in this respect the above-cited document U.S. Pat. No. 5,604,410), which are realized by lug-like projections 12 facing the respective adjacent anode strip. They effect locally delimited boosting of the electric field, so that the delta-shaped individual discharges (not shown) are ignited exclusively at these locations 12. With the exception of the two outer anodes 10, 11, the other anodes 9 have a double structure 9a, 9b. All the anodes 9-11 are covered with a dielectric layer of soldering glass (not shown). The anodes 9-11 and cathodes 8 are each extended at one end and on the back plate 2 lead out of the interior of the discharge vessel on both sides, in such a manner that the associated anodic and cathodic leadthroughs are arranged on opposite sides of the back plate 2. On the edge of the back plate 2, the electrode strips 8-11 each merge into the abovementioned cathode-side 6 or anode-side 7 supply conductor. The supply conductors 6, 7 serve as contacts for connection to preferably an electric pulsed voltage source 13. For a flat lamp with, for example, a 15″ diagonal (not shown), a set of electrodes (not shown) having 12 cathode strips and 11 double anode strips as well as two outer single anodes is provided. Each anode strip has in each case 13 projections to ignite the individual discharges along each of the two longitudinal sides.

Although the invention has been explained in detail above on the basis of the example of a flat dielectric barrier discharge lamp, it is not restricted to this form of lamp. Rather, its advantageous effects also result in the case of lamps with other shapes of vessel, for example in the case of tubular lamps. In the latter case, the set of electrodes comprises two or more elongate electrodes which are arranged parallel to the lamp longitudinal axis on the wall of the tubular discharge vessel.

What is claimed is:

1. A dielectric barrier discharge lamp having
a discharge vessel, the wall of which encloses a discharge medium,
a set of electrodes for generating dielectric barrier discharges in the discharge medium, with a dielectric barrier action in respect of at least some of the set of electrodes,
a phosphor mixture, which is applied to part of the wall of the discharge vessel,
a phosphor mixture comprising the following phosphor components:
R: (Y,Gd)BO₃:Eu,
LaPO₄: (Tb) or LaPO₄: (Ce,Tb),
B: BaMgAl₁₀O₁₇:Eu
whereby
the following applies to the proportions by weight formed by the phosphor components R, G, B in the mixture:
0.05≦R≦0.15, 0.50≦G≦0.70, 0.20≦B≦0.40 and R+G+B=1.

2. The dielectric barrier discharge lamp as claimed in claim 1, in which the following applies to the proportions by weight in the mixture:
0.06≦R≦0.12, 0.58≦G≦0.66, 0.25≦B≦0.35 and R+G+B=1.

3. The dielectric barrier discharge lamp as claimed in claim 1, in which the discharge vessel contains xenon as discharge medium.

4. The dielectric barrier discharge lamp as claimed in claim 3, in which the xenon filling pressure is in the range between 50 and 200 mbar.

5. The dielectric barrier discharge lamp as claimed in claim 3, in which the xenon filling pressure is in the range between 100 and 150 mbar.

6. The dielectric barrier discharge lamp as claimed in one of the preceding claims, in which the discharge vessel is formed to be flat and comprises a back plate and a front plate for the light to emerge, which is at least partly transparent to light.

7. The dielectric barrier discharge lamp as claimed in one of claims 1 to 5, in which the discharge vessel is tubular.

8. The dielectric barrier discharge lamp as claimed in claim 6, having a dielectric layer between at least part of the set of electrodes and the discharge medium.

9. The dielectric barrier discharge lamp as claimed in claim 8, in which the set of electrodes comprises two or more elongate electrodes which are arranged on the wall of the discharge vessel.

10. The use of a dielectric barrier discharge lamp with a color temperature of 10,000 K or above for viewing X-rays.

11. The use as claimed in claim 10, wherein the color temperature is more than 20,000 K, preferably more than 30,000 K, particularly preferably more than 40,000 K.

12. The use as claimed in claim 10, wherein the dielectric barrier discharge lamp has the features described in one of claims 1 to 9.
